(19) United States
(12) Patent Application Publication
(10) Pub. No.: US 2006/0031223 A1
(43) Pub. Date: Feb. 9, 2006

(54) Virtual private network system

(76) Inventor: John M. Dole, San Francisco, CA (US)

Correspondence Address: Henneman & Saunders, 714 W. Michigan Ave., Three Rivers, MI, 49093, US

(21) Appl. No.: 10/832,982

(22) Filed: Apr. 27, 2004

(51) Int. Cl. G06F 17/30

(52) U.S. Cl. 707/10

(57) ABSTRACT

A virtual private network 10 system running on a computer server 11 such that a plurality of end users 12 can access the virtual private network over the internet 14. Applications 26 are accessed through a plurality of web page displays 72, 100, 408. A client request 402 causes a page object 406 to be created which page object retrieves a template 44 with placeholders 258. Data is obtained from a database 38 to fill in the placeholders 258, including a virtual operating system 76 type of user interface, wherein folders 78 and files 80 can be treated by each user 12 as though that user has complete control of the virtual operating system 76 while not changing the arrangement and existence of folders 78 and files 80 for other users.

### BACKGROUND OF THE INVENTION

1. Field of the Invention

This invention relates generally to the field of computer networking methods and apparatus, and more particularly to a virtual private network system that can easily be made available to a plurality of user groups and which features a unique virtual operating system type of user interface.

2. Description of the Background Art

The need for private networks is well known in the art. Communication by means more private and secure than ordinary Internet email services, and the like, is vital to the success and security of many businesses. Because of the expense associated with establishing a completely private physical network over extended distances, “virtual” private networks have been developed which generally provide privacy and security comparable to that of a private physical network, using the established Internet as a transmission medium.

Prior to the present invention, in order to have a virtual private network a user has had to maintain a private server, such that all communications on the virtual private network pass through that server. The server is protected by a firewall and other security means such that communications passing there through are afforded the required degree of security. Also, in the prior art, virtual private networks have provided a generally secure communications means, but have not provided software for accomplishing the desired communications over such network. Therefore, users have been required to acquire and install a compatible software package on each computer that will be used to access the virtual private network.

It would be desirable to have a virtual private network which can easily be configured such that it does not require a substantial initial investment on the part of the user. It would further be desirable to have a virtual private network which provides its own communication software and does not require a particular software package or type of software to use, such that users could access the virtual private network from essentially any Internet capable computer. However, to the inventor's knowledge, neither of these features has been available in the prior art.

### SUMMARY

It is an object of the present invention that a client can have a virtual private network without a substantial initial investment.

It is another object of the present invention that a client can have a virtual private network without the expense and trouble of maintaining the necessary hardware and/or software.

It is still another object of the present invention that the virtual private network can be accessed from any Internet capable computer.

It is yet another object of the present invention to provide a virtual private network user interface that is easy and intuitive to use.

It is still another object of the present invention that applications can be added to the virtual private network as they are developed.

The present invention overcomes the problems associated with the prior art by providing a system and method for a virtual private network which can be accessed and used by organizations and groups without a substantial initial investment either in hardware or in application software. According to the present invention, a virtual private network is provided on a server such that multiple clients can use the virtual private network system. Clients can sign up for the service on the Internet and begin using the service as soon as they are signed up. The service provides a virtual private network such that mail is received only from persons who are signed on to the service provider server, and whom the client has authorized to send mail to the client. A document interface is provided in the form of a virtual operating system such that documents, folders, and the like are presented to the user in a familiar format. Since no additional email software or other communications software is required, the client can access the virtual private network from any Internet capable computer having an Internet connection and a browser for accessing the internet. The virtual operating system type of interface is made possible by a unique method for constructing appropriate folder and file arrangements, as requested by the end user. Since the inventive virtual private network is implemented using a unique virtual private network adapter, additional applications can be added as a service to users of the virtual private network.

These and other objects and advantages of the present invention will become clear to those skilled in the art in view of the description of modes of carrying out the invention, and the industrial applicability thereof, as described herein and as illustrated in the several figures of the drawing. Any objects or advantages listed are not an exhaustive list of all possible advantages of the invention. Moreover, it will be possible to practice the invention even where one or more of the intended objects and/or advantages might be absent or not required in the application.

Further, those skilled in the art will recognize that various embodiments of the present invention may achieve one or more, but not necessarily all, of the described objects and/or advantages. Accordingly, objects and/or advantages described herein are not essential elements of the present invention, and should not be construed as limitations.

### BRIEF DESCRIPTION OF THE DRAWINGS

FIG. 1 is a block diagram depicting some basic components of the inventive virtual private network in relation to the Internet;

FIG. 2 is a block diagram of a database such as might be used in conjunction with the invention;

FIG. 3 is a diagrammatic representation of an example of a greeting display screen, which is the screen that will be displayed to a user after the user has signed into the present inventive virtual private network system;

FIG. 4 is a diagrammatic representation of an example of a message display screen;

FIG. 5 is a flow diagram illustrating a process for creating a virtual file arrangement for a virtual operating system;

FIG. 6 is a graphical representation of a greeting page template;

FIG. 7 is a flow diagram illustrating a process for presenting a virtual document.

FIG. 8 is a graphical representation of a document page template;

FIG. 9 is a block diagram depicting operations of an extensible virtual operating system adapter, according to the present invention; and

FIG. 10 is a flow diagram illustrating a data storage method according to the present invention.

### DETAILED DESCRIPTION

This invention is described in the following description with reference to the Figures, in which like numbers represent the same or similar elements. While this invention is described in terms of modes for achieving this invention's objectives, it will be appreciated by those skilled in the art that variations may be accomplished in view of these teachings without deviating from the spirit or scope of the present invention. The embodiments and variations of the invention described herein, and/or shown in the drawings, are presented by way of example only and are not limiting as to the scope of the invention. Unless otherwise specifically stated, individual aspects and components of the invention may be omitted or modified, or may have substituted therefore known equivalents, or as yet unknown substitutes such as may be developed in the future or such as may be found to be acceptable substitutes in the future. The invention may also be modified for a variety of applications while remaining within the spirit and scope of the claimed invention, since the range of potential applications is great, and since it is intended that the present invention be adaptable to many such variations. For example, the present invention may be implemented using any combination of computer programming software, firmware or hardware. As a preparatory step to practicing the invention or constructing an apparatus according to the invention, the computer programming code (whether software or firmware) according to the invention will typically be stored in one or more machine readable storage devices such as fixed (hard) drives, diskettes, optical disks, magnetic tape, semiconductor memories such as ROMs, PROMs, etc., thereby making an article of manufacture in accordance with the invention. The article of manufacture containing the computer programming code is used by either executing the code directly from the storage device, by copying the code from the storage device into another storage device such as a hard disk, RAM, etc. or by transmitting the code on a network for remote execution. The method form of the invention may be practiced by combining one or more machine readable storage devices containing the code according to the present invention with appropriate standard computer hardware to execute the code contained therein. An apparatus for practicing the invention could be one or more computers and storage systems containing or having network access to computer program(s) coded in accordance with the invention.

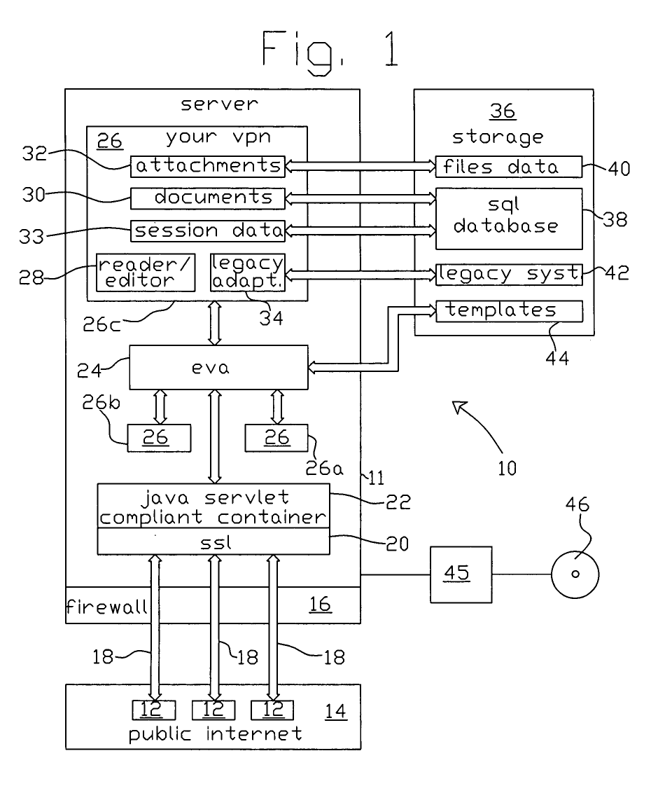

An embodiment of an example of the inventive virtual private network is depicted in the view of FIG. 1 and is designated therein by the general reference character 10. The virtual private network (“VPN”) 10 allows end users 12 to communicate with a VPN server 11 via the Internet 14 through a firewall 16 using a secure connection 18 through a secure sockets layer (“SSL”) 20. In the simplified example of FIG. 1, three of the end users 12 are depicted, although a great many end users 12 will access the VPN 10 via the Internet 14.

A commonly available Java Servlet Compliant Container 22 (version 2.3 in this embodiment) provides an engine for running the Java Servlets which enable the present invention, as will be discussed in more detail hereinafter. An Extensible Virtual Private Network (“EVA”) 24 module is the programming, written in Java, which interprets and passes on data from the end users 12 to one or more VPN Applications 26. The EVA 24 also constructs http pages using data obtained from the VPN Applications 26 for presentation to the end users 12, as will be discussed in detail hereinafter. In the example of FIG. 1, three of the VPN Applications are depicted. It is anticipated by the inventor that such VPN Applications will include dedicated applications such as a Project Management application 26a and a Calendaring application 26b, however such applications have not yet been developed. The presently described embodiment of the invention does have a “Your VPN” 26c application, which acts much like conventional secure email applications, except as further described herein. That is, Your VPN 26c allows end users 12 to send, receive, add to, append files to, and further manipulate messages to and from other particular end users 12.

As can be seen in the view of FIG. 1, Your VPN 26c has a Reader/Editor module 28, a Documents module 30, an Attachments module 32, a Session Data module 33 and, in this example, a Legacy Adaptor(s) module 34. Data is stored on one or more storage devices 36. In the example of FIG. 1, such data includes an SQL database 38, which will be discussed in detail hereinafter, a files data 40 portion wherein user files that are to be shared among users and/or “attached” to messages are stored, and a legacy systems 42 data portion which stores data pertaining to legacy systems. As used herein, the term “legacy systems” refers to business applications which an end user might wish to use in conjunction with Your VPN 26c. At present, no Legacy Adaptor(s) 34 have been developed and no legacy systems 42 data is stored. However, it is anticipated by the inventor that these will be requested by users 12, and these will be developed on a custom basis as required by the end users 12. A Templates 44 data portion has templates in the form of hyper text markup language (“HTML”) template files, the use of which will be discussed in greater detail hereinafter.

The editor/reader module 28 acts in the manner of an email or simple word processing program to allow the user to see and edit original messages and other authorized messages posted on the VPN 10 system. The Documents module 30 communicates data to and from the Database 38, which data is the text of messages posted between users of the VPN 10 system, and which are presented and may be edited using the editor/reader module 28 as described hereinafter.

The Attachments module 32 stores and retrieves the Files data 40 which data includes attachments that can, optionally, be appended to messages and/or transmitted to other users by the end users 12.

As is generally provided with computer systems, the server 11 is provided with a removable media reader 45 through which program files, including those described herein, can be loaded into the server 11 from a removable media 46 such as a CD ROM, or the like.

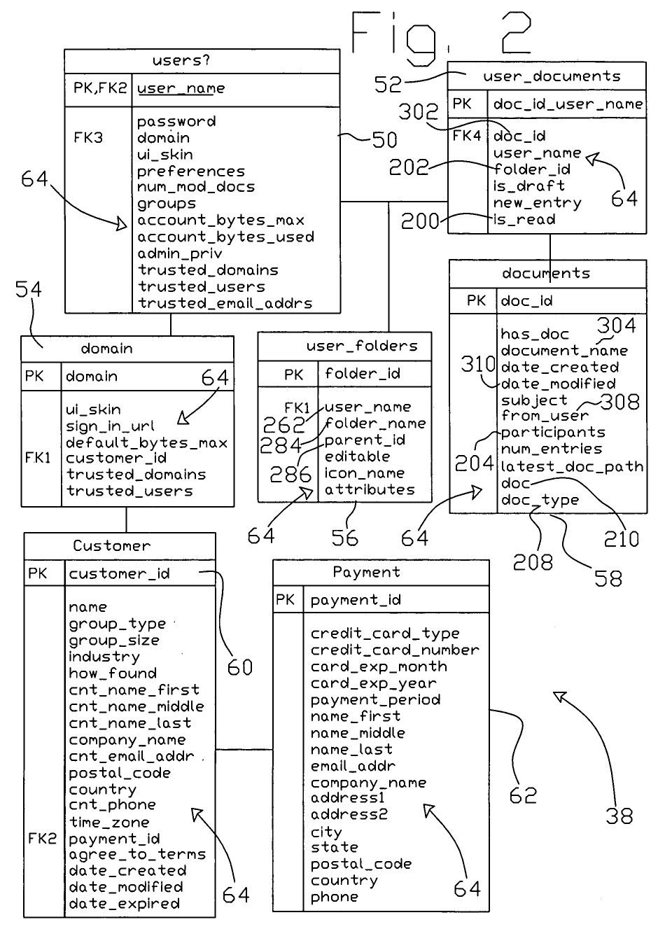

FIG. 2 is a block diagram depicting an example of the content of the SQL database 38. In the Example of FIG. 2, the database 38 has tables entitled Users 50, User_Documents 52, Domain 54, User Folders 56, Documents 58, Customer 60, and Payment 62. Each of the data tables 50 through 62 contains a plurality of data fields 64. While the content of some of the data fields 64 of these data tables 50 may generally be self evident to one skilled in the art, for the sake of clarity, each of the fields of the User 50, User Documents 52, Domain 54, User Folders 56 and Documents 58 tables is briefly described below. It should be noted that the diagram of FIG. 2 depicts all of the fields which are presently actually in the data base 38. However, not all of these data fields 64 will be relevant to the presently claimed invention, nor are they all actually used in the practice of the presently claimed invention. The use of the data fields 64 that are directly relevant to the practice of the present invention will be discussed in greater detail hereinafter.

The Domain 54 table will generally contain records describing a private domain, including:
Domain: [primary key] the name of a specific YourVPN private domain (such as “mycompany.yourvpn.com”)
Ui_skin: the directory name on the server of user interface templates.
Sign_in_url: the URL of the sign in page.
Default_bytes_max: the maximum number of bytes allocated for each user.
Customer_id: identification of the customer that created the domain.
Trusted_domains: a list of YourVPN domains that have been elected by the administrator for authorized communication.
Trusted_users: a list YourVPN users in other domains that may be communicated with.

The Users 50 table contains records describing a user.
User_name: [primary key] the name of YourVPN user. (such as
“bill@mycompany.yourvpn.com”)
Password: the user's password.
Domain: the domain this user belongs to.
Ui_skin: a directory name on the server of user interface templates.
Preferences: user preferences object.
Num_mod_docs: the number of user_documents records where the “is_read” field is set to false.
Groups: a list of group objects which contain lists of users.
Account_bytes_max: the maximum number of bytes allocated for user. Overrides domain.default_bytes_max.
Account_bytes used: the number of bytes currently used by user.
Admin_priv: administration privileges for this user. Possible values: None, Domain or All.
Trusted_domains: a list of YourVPN domains that user has elected to communicate with.
Trusted_users: a list of YourVPN users in other domains that user has elected to communicate with.
Trusted_email_addrs: a list of external email addresses that user has elected to communicate with.

The User_folders 56 table contains records describing a folder owned by a user.
Folder_id: id of a user's folder.
User_name: user that owns this folder.
Folder_name: name of a folder assigned by user.
Parent_id: folder identification of the folder that this folder resides in.
Editable: if true, user may edit, move or delete the folder.
Icon_name: name of graphic used to represent this folder in the user interface.
Attribrutes: additional properties for this folder.

The User_documents 52 table contains records describing document information specific to a given user.
Doc_id_user_name; [primary key] identification of user specific information for a document.
Doc_id: identification of documents record containing content of document and other fields shared by participants in the document.
User_name: name of the user that owns this record.
Folder_id: identification of folder where user has elected to store this document.
Is_draft: if true, the user has not published this document to its other participants.
New_entry: document content item that the user has not yet published to other participants.
Is_read: if true, the user has viewed the document in its current state.

The Documents 58 table contains records describing content and attributes shared by participants in a document.
Doc_id: [primary key] identification of document.
Has_doc: if true, this document has one or more uploaded files associated with it.
Document_name: file name of last file uploaded to this document.
Date_created: date the document was created.
Date_modified: date the document was last modified.
Subject: name of document assigned by user displayed in the user interface.
From_user: name of user who created this document.
Participants: list of users that may view this document.
Num_entries: length of list of content entries stored in the doc field.
Lastest_doc_path: full path on server of last uploaded file.
Doc: list of content entries that are displayed in the user interface.
sDoc_type: type of document. Indicates how the document content should be displayed.

The Customer 60 and Payment 62 tables contain data pertinent to a particular customers. According to the present invention, a plurality of customers can purchase the virtual private network service from the provider of the VPN 10. The Customer 60 and Payment 62 tables contain data pertinent to such customers which are not directly relevant to a description of the presently claimed invention.

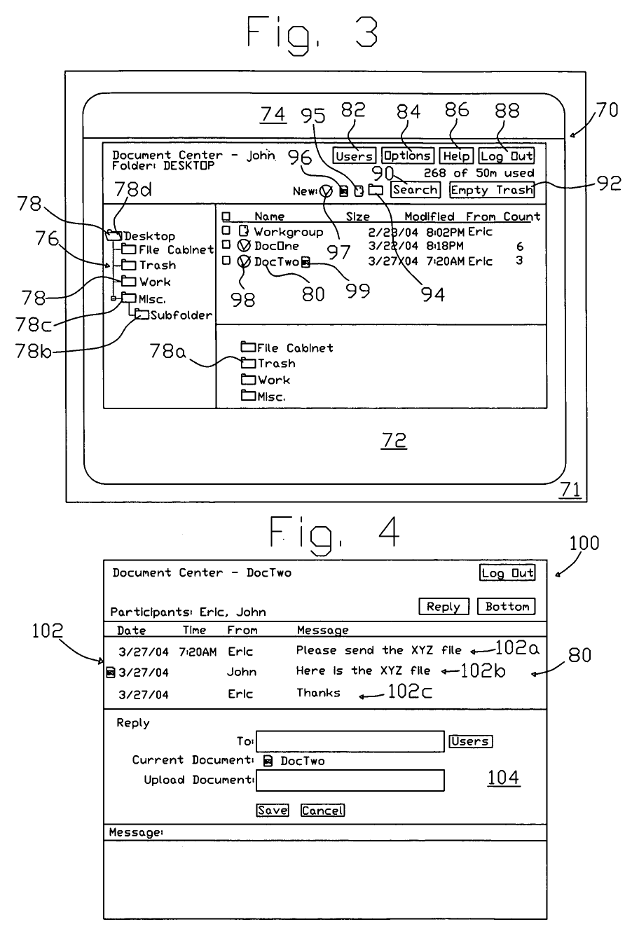

FIG. 3 is a diagrammatic representation of an example of a greeting display screen 70, which is the screen that will be displayed to a user 12 on a computer monitor 71 after the user 12 has signed into the present inventive VPN 10 system. Of course, in order to reach the greeting display screen 70, the user 12 will have had to go through a sign on page (not shown) wherein the user is required to enter a user name and password. The sign on page is not significantly different from such sign on pages known in the prior art and in common usage. In the diagram of greeting display screen 70 of FIG. 3 it can be seen a greeting display 72 is displayed using essentially any commonly available web browser. A web browser display 74 area is typical of a heading area such as might be displayed by any of the commonly available web browsers, and the details of the web browser display 74 portion of the greeting display screen 70 are omitted from the view of FIG. 3, since such details are peculiar to whatever particular browser is being used, and since such details are not relevant to the present invention.

In the greeting display 72 can be seen a user interface portion that is a virtual operating system 76 display. The virtual operating system display 76 will be readily recognized as being similar to the representation of folders 78 and documents 80 such as are commonly displayed in conventional prior art graphical user interface (“GUI”) types of operating systems. However, as will be discussed in greater detail hereinafter, the virtual operating system 76 of the present invention differs significantly from prior art “real” operating systems in ways including that the virtual operating system 76 does not have the folders and documents stored systematically in the manner of a prior art operating system. Rather, the content and arrangement of the virtual folders 78 and virtual documents 80 will vary according the user 12 and other situational factors and, therefore, the relationship and content of the virtual folders 78 and virtual documents 80 will be constructed according to the following description of the present inventive method.

The greeting display 72 has a users button 82 which takes the user 12 to a page displaying other available users 12, and an options button 84 which take the user 12 to a page that allows the user 12 to change his or her password, and the like. A help button 86 takes the user 12 to a help page wherein detailed instructions for operation of the Your VPN 26c are presented. A log out button 88 signs the user 12 out of the Virtual Private Network 10 system. A search button 90 allows the user 12 to search the content of all documents 80 available to that user 12. An empty trash button 92 removes content of a trash folder 78a for that particular user 12. It should be noted that, unlike in a conventional operating system, since a document 12 might, and generally will, be available to several users 12, moving a document 80 to a particular folder 78 (including, but not limited to the trash folder 78a) will affect only how that particular document 80 is presented to that particular user 12 placing it there. Further, each user can, and often will, move documents 80 and/or folders 78 to the trash folder 78a, thereby essentially deleting such moved items just as in an conventional operating system. However, also as in a conventional operating system, until the trash folder 78a has been emptied, items therein can be recovered by moving them back out of the trash folder 78a. Movement of items to the empty trash folder 78a and the use of the empty trash button 92 will only remove documents 80 therein from among those documents 80 which are presented to that user 12. The document 80 might still be in use by other users 12.

A new folder button 94 takes the user 12 to a page where a new folder 78 can be added to the greeting display 72. A new contact button 95 takes the user 12 to a page where a new authorized user can be added. A new attachment button 96 takes the user 12 to a page where a file can be uploaded and, optionally, attached to a document 80. A new document button 97 takes the user 12 to a page where a new document 80 can be started. The page accessed by the new document button 97 allows the user 12 to choose to whom the document is to be sent, and to enter the content of the document message. A document icon 98 indicates the location on the greeting display 72 of the name of a document 80. An attachment icon 99 indicates that a file attachment is associated with (attached to) the document 80 beside which the attachment icon 99 appears.

FIG. 4 is a diagrammatic representation of an example of a document display 100. The document display 100 is an example of one of the many web pages that can result from interactions such as those previously discussed in relation to the greeting display 72. In this example, by clicking on the document 80 entitled DocTwo in the example of FIG. 3, the example of the web page shown in FIG. 4 will be produced. As can be seen in the example of FIG. 4, one or more entries 102 are in the DocTwo document 80. A first entry 102a is put within the document 80 when the document 80 is created, subsequent entries 102a and 102b are added as the document 80 is “passed around” and additional users 12 (or the originating user 12 again, as in this example) add their comments. As can be seen by the attachment icon 99 beside the second entry 102b, there is a file attached to that entry 102b, and thus to the DocTwo document 80. A reply portion 104 of the document display 100 provides an opportunity for the instant user 12 to add to the document 80 and circulate it again to the relevant users 12.

As described above, the inventive virtual operating system 76 includes virtual folders 78 and virtual documents 80. As was also briefly discussed above, the virtual folders 78 are distinguishable from prior art folders in several important aspects. Some of the aspects of the virtual folders 78 are that the virtual folders 78 emulate the directory system in a non-virtual operating system. For example, a virtual folder 78 may optionally have an plurality of “children” or sub-folders 78b (as in a conventional operating system) and a virtual folder 78 may have only one parent 78b or super-folder (also, as in a conventional operating system). However, the virtual folders 78 do not exist physically on the server 11. Instead, they exist as abstractions in the application's database 38 and, therefore, might be arranged differently by each user 12.

According to the present invention, the documents 80 are collaborative documents, meaning that different users 12 can, and do, contribute to many of the documents 80. In order to accomplish this, while allowing each user 12 the freedom to file, store, delete, and otherwise treat each of the documents 80 as each user 12 would generally be able to do in a “real” operating system, the documents 80 have associated with each of them certain information. Each virtual document 80 will have associated therewith discrete document information for each participant (user 12) including whether the user has viewed the document in its latest form (an is_read 200 record in the user documents 52 table of FIG. 2, if true, will cause the document name to be highlighted in the display), identification of the folder (folder_id 202) where the user 12 has stored the document 80, since each user 80 can store the document 80 as her or she chooses and can even move the document 80 to the trash folder 78a, or the like, while other users 12 still are using and/or have access to that same document 80. How this is done will be described in more detail hereinafter.

The documents 80, in order to be useful in the inventive virtual operating system 76 should have associated therewith a list of participants (users12) who may view and edit the document 80 (a participants field 204 in the documents table 58), an indication of what type of document 80 it is and, therefore, how to present the document 80 (a doc_type field 208), and a list of items that make up the content of the document 80 (a doc field 210). The doc field 210 can, optionally, contain a list of message entries, a list of contact entries, or the like, depending upon the document type. This model of a document 80 is general enough to describe essentially any type of document 80 where virtual collaboration is desired.

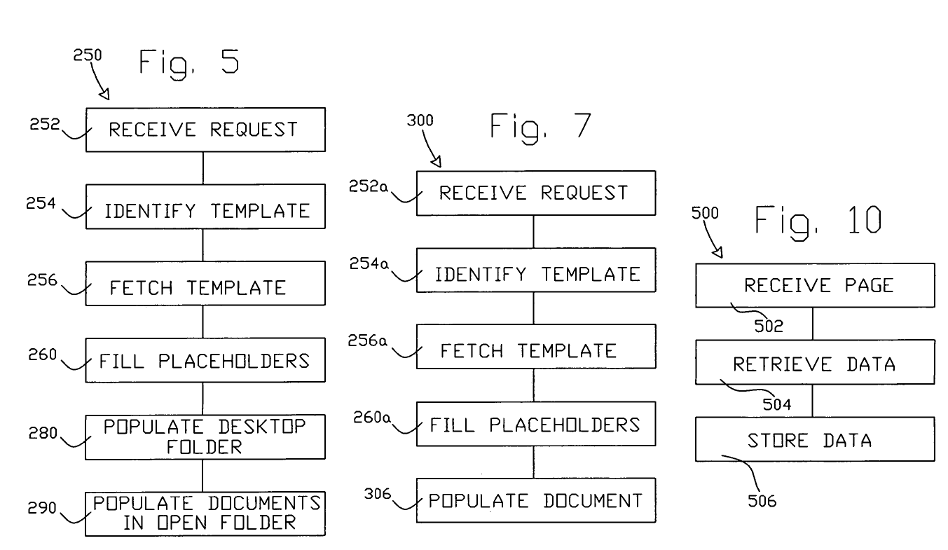

FIG. 5 is a flow diagram depicting an example of the present inventive method for creating the greeting display 72 of FIG. 3, including one iteration of the virtual operating system 76. According to the greeting display method 250, in a “receive request” operation 252, the server 11 receives a request in the form of a Uniform Resource Locator (“URL”). One skilled in the art will recognize that the URL will contain the address of the server 11, and can also contain additional pointers. In this case, the URL will contain a pointer indicative of the type of page that is being requested by the user 12. In an “identify template” operation 254, the particular template required is determined by looking up the template pointer in the URL in a simple table. In a “fetch template” operation 256, a template 44 (FIG. 1) is retrieved from the data storage 36 medium.

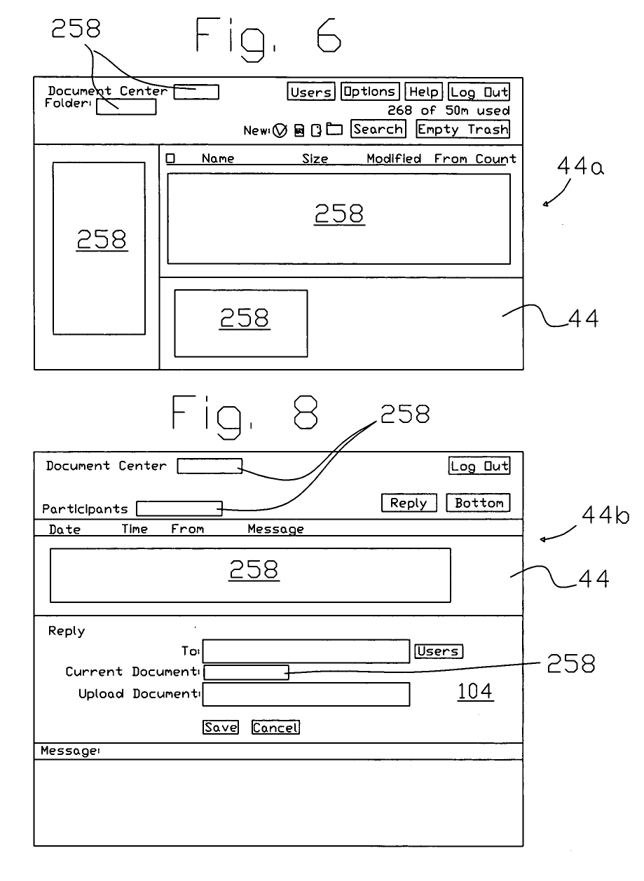

FIG. 6 is a graphical representation of a template 44. Of course, the templates 44 are in the form of HTML documents and are never actually rendered in the form shown in FIG. 6. However, the representation of FIG. 6 illustrates the fact that the templates 44 have a plurality of placeholders 258, which reserve positions for data to be retrieved and inserted therein. FIG. 6 is an example of a greeting page template 44a.

In a “fill placeholders” operation 260 certain of the placeholders 258 are filled as follows: The name of the present user 12 is known from the URL that has been received, as is the identity of which folder 80 is open. A “desktop” folder 78d is the highest order parent folder for each user, and will be the folder 78 which is initially displayed as open when the user 12 first accesses the greeting display 72 page.

In a “populate desktop folders” operation 280, the folders 78 are created for display on the greeting display 72 page. Using fields 64 in the user_folders table 56, all folders having the correct user_name field 262 and folder_name field 264 are used to populate the virtual operating system 76 display. The parent_id folder 266 determines the correct position of each folder 78 in the virtual operating system 76 display, such that each folder 78 will be displayed as a subfolder 78b of the parent folder 78c identified in its corresponding parent_id field 266. In a “populate documents in open folder” operation 290 all of the documents 80 that are in the open folder 78 (the desktop folder 78d in the example of FIG. 3) are provided and listed, as shown in the view of FIG. 3. In the example of FIG. 3, only one document 80 (named DocTwo) is shown. All documents 80 in the database 38 that are associated with the appropriate user_name field 262 and folder_id field 202 are listed. The is_read field 200 determines whether the document icon 98 is filled in.

FIG. 7 is a flow diagram of a documents display method 300, and FIG. 8 is a diagrammatic representation, similar to the view of FIG. 6, depicting a document display template 44b. In the documents display method 300, a receive request operation 252a, an identify template operation 254a, a fetch template operation 256a and a fill placeholders operation 260a are all similar to the previously described corresponding operations 252 through 260, with the exception that the data is peculiar to the particular type of request. When the URL is received at the server 11 for a request for a document display, a doc_id 302 is included. The doc_ID 302 is a randomly generated number that is unique to each document 80 stored at the server 11. A document_name field 304 and the participants 204 field are used to populate the relevant placeholders 258 in the document display template 44b. In a “populate document” operation 306 the content of the document is provided into the document template 44b. The doc field 210 is an ordered list of the entries in the document. A from_user field 308 provides the name of the user 12 that sent each entry. A date_modified field 310 provides the date each new addition to the document 80 was made.

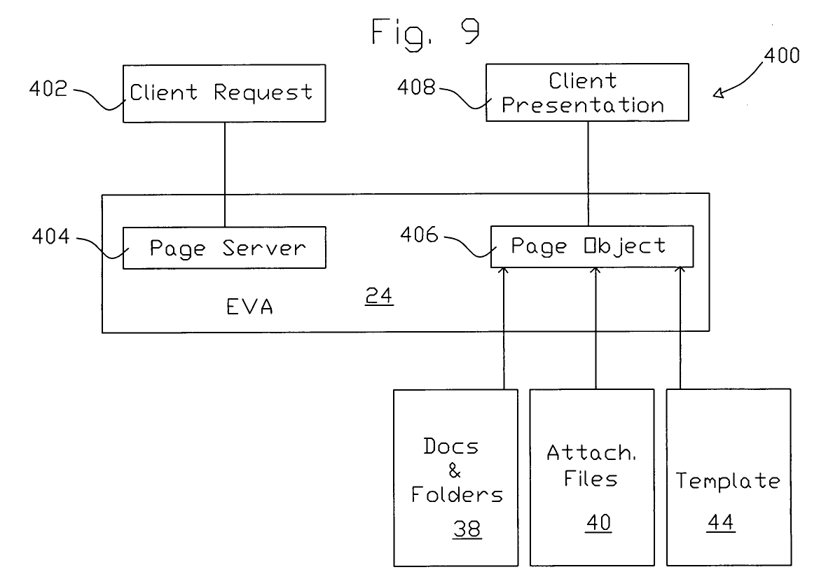

FIG. 9 is a block diagrammatic representation showing yet another perspective as to how the EVA serves a client request. As can be seen in the view of FIG. 9, in a page compilation process 400, a client request 402 (in the form of a URL, as discussed above, is received by a page server 404 software portion in the EVA 24. The EVA then creates an appropriate Java page object 406. More particularly, in this example of the present invention, The HTML template is compiled for the given page object into a list of String objects for static elements and Method objects for data unique to the user's request. Placeholder strings in the template are replaced with the actual corresponding Method objects of the page object allowing data unique to the user's request to be combined with the template's static elements efficiently.

The page object 406 is provided with the appropriate template 44, and will populate the template 44 with documents and folders from the data base 38 and, if present, with attachment files 40. The page object 406 will then produce a completed HTML page which is sent to the user 12 as a user presentation 408, examples of which are the greeting display 72 and documents display 100, previously discussed herein. It should be noted that data sent from the users 12 in the form of HTML pages is parsed and recorded in the appropriate fields of the data base 38 such that the data is available for constructing the virtual operating system 76 displays according to the methods discussed herein.

FIG. 10 is a flow diagram representing a data storage method 500 according to the present invention. One skilled in the art will recognize that the unique aspects of the present invention involve the arrangement of data in the database 38 and how that data is used to create the inventive virtual operating system 76 and the remainder of displays shown and/or discussed herein. Once one understands how the data is arranged and how it is used, one skilled in the art will recognize that storing the data in the arrangement described will be a relatively straight forward process. In a “receive page” operation 502 data is received at the EVA module 24 in the server 12, and in a “retrieve data” operation 504 the relevant data is separated for storage. In a “store data” operation 506, the data is stored in the database 38 in the fields and tables discussed previously herein.

Deviations from the particular embodiments shown will be apparent to those skilled in the art, particularly in view of the foregoing disclosure. Indeed, the examples presented herein are intended to be relatively simple, so as not to obscure the invention with details well know to software and database programmers.

Further, those skilled in the art will recognize that the present invention includes several novel aspects, which are considered to be inventive both individually and in combination with one another. Therefore, no single aspect of the present invention should be considered an essential element of the present invention. Indeed, it is anticipated that in various particular embodiments one or more inventive features of the invention may be omitted, while retaining other inventive features.

I claim:

1. A computer system for providing a virtual private network over the public Internet such that a user can communicate with other users, the computer system comprising:
a server computer having a connection to the Internet;
a data storage medium having data stored therein;
a processing unit for processing data and code; and
a memory device for storing said data and said code;
said code including a virtual private network adaptor for creating a web page representation of a communications user interface.

2. The computer system of claim 1, wherein:
said web page includes a virtual operating system such that documents are stored within folders of said virtual operating system.

3. The computer system of claim 2, wherein:
said documents can be selective moved into and out of folders by a user without affecting the placement of documents for other users.

4. A virtual operating system, comprising:
a document stored on a computer;
an indexing means for associating the document to a file name; and
a page producing means for producing a display having thereon a file having the file name.

5. The virtual operating system of claim 4, wherein:
a representation of the document can be viewed by opening the file.

6. The virtual operating system of claim 4, wherein:
the indexing means has a data field representing a particular user, such that the file name is associated with that particular user.

7. A data retrieval method, comprising:
receiving a user request, said user request having a user name associated therewith;
retrieving a template, said template having place holders therein;
populating at least some of said place holders with elements of a virtual filing system;
said virtual filing system having at least one folder such that said folder is associated with said user name.

8. The data retrieval method of claim 7, wherein:
said folder is associated with at least one document.

9. A computer-readable medium having code embodied therein for causing an electronic device to perform the method of claim 7.

10. A method for using stored data to create a user display, comprising:
locating folder a plurality of folder names associated with a particular user name;
arranging said folder names in a hierarchical arrangement; and
creating a graphical representation of at least some of the folder names such that the folder names are arranged according to the hierarchical arrangement.

11. The method of claim 10, and further including:
locating a plurality of document names associated with at least one of the folder names; and
displaying at least some of a plurality of documents identified by said document names.

12. The method of claim 11, wherein:
the documents displayed are associated with an open folder.

13. A computer database, comprising:
a first table having therein information associating a user name with at least one document identification;
a second table associating the user name with at least one folder identification; and
a third table having therein information pertaining to a document.

14. The computer database of claim 13, wherein:
said first table has a first field for associating the document identification with a folder identification.

15. The computer database of claim 13, wherein:
said second table has a first field for associating a folder name with the folder identification.

16. The computer database of claim 15, and further including:
a second field for identifying a parent folder.

17. The computer database of claim 13, wherein:
said third table has a field for storing document content.

18. The computer database of claim 13, wherein:
said third table has a field for associating the document identification with a document name.

19. The computer database of claim 13, wherein:
said third table has a field for identifying at least one user who has participated in the production of the document.

20. The computer database of claim 13, wherein:
said third table has a field indicating a date on which the document was last modified.

21. A method for storing computer documents, comprising:
receiving a data set from a client;
separating said data into a purality of data fields; and
storing said data fields in a data storage medium, wherein
said data fields include a user identification, a folder identification, and a document identification.

22. The method for storing computer documents of claim 21, wherein:
said data fields are stored in tables such that a graphical representation of folders and documents can be individualized according to an associated user identification.

23. A computer-readable medium having code embodied therein for causing an electronic device to perform the method of claim 21.

24. A computer program product comprising a computer usable medium having a computer readable code embodied thereon configured to operate on a computer, comprising:
a first routine for creating simulated folders such that a representation of a folder hierarchy can be created for each individual user; and
a second routine for populating at least one of said simulated folders with at least one document name associated with that simulated folder.

25. The computer program product of claim 24, wherein:
the at least one document name is associated with said simulated folder generally when said simulated folder is presented to a particular user.

26. A computer-readable medium having stored therein a data structure comprising:
a first table containing data correlating at least one user to at least one virtual folder; and
a second table containing data correlating at least one document to said virtual folder.

27. The computer-readable medium of claim 26, wherein:
said first table has a folder identification field, a user name field, and a folder name field.

28. The computer-readable medium of claim 27, wherein:
said first table further includes a parent identification field such that each folder can optionally be associated with a parent folder.

29. The computer-readable medium of claim 28, wherein:
each folder can optionally be associated with one and only one parent folder.

30. The computer-readable medium of claim 26, and further including:
a customer table containing data fields for identifying one of a plurality of customers that can access the data structure.
